(19) United States
(12) Patent Application Publication
(10) Pub. No.: US 2011/0088979 A1
(43) Pub. Date: Apr. 21, 2011

(54) CARGO TRANSPORTER WITH AUTOMATIC DATA COLLECTION DEVICES

(75) Inventors: John S. Bandringa, Everett, WA (US); Ryan R. White, Ankeny, IA (US); Jerry Allen Johnson, Cedar Rapids, IA (US); Christopher Charles Johnston, Kirkland, WA (US); Michael J. Wells, Everett, WA (US); Joshua Merritt Hansen, Everett, WA (US); Matthew F. Willkens, Seattle, WA (US); Steven Tzu-Yun Peng, Seattle, WA (US); Jeffrey L. Hovorka, Everett, WA (US); Cary Daniel Cronin, Lynnwood, WA (US)

(73) Assignee: INTERMEC IP CORP., Everett, WA (US)

(21) Appl. No.: 12/971,388

(22) Filed: Dec. 17, 2010

Related U.S. Application Data
(62) Division of application No. 11/672,776, filed on Feb. 8, 2007.
(60) Provisional application No. 60/771,667, filed on Feb. 8, 2006.
(60) Provisional application No. 60/772,609, filed on Feb. 9, 2006.
(60) Provisional application No. 60/772,610, filed on Feb. 9, 2006.
(60) Provisional application No. 60/744,126, filed on Apr. 1, 2006.
(60) Provisional application No. 60/804,441, filed on Jun. 11, 2006.

(51) Int. Cl. B66F 9/075; B66F 9/06; B66F 9/20

(52) U.S. Cl. 187/222

(57) ABSTRACT

A cargo transportation device includes a lift assembly for raising and lowering cargo and an operator cabin in which an operator controls the lift assembly. A load backrest is coupled to the cabin, and an automatic data collection device, which is configured to interrogate wireless communication devices, is coupled to the load backrest. The cargo transportation device includes a computing device having logic for controlling the automatic data collection device and logic for controlling the lift assembly, and a display device in communication with the computing device. The display device is coupled to the cabin and configured to provide the operator with information from the computing device.

### CROSS-REFERENCE TO RELATED APPLICATIONS

This application is a division of U.S. patent application Ser. No. 11/672,776, filed Feb. 8, 2007, now pending, which claims benefit under 35 U.S.C. §119(e) of U.S. Provisional Patent Application No. 60/771,667, filed Feb. 8, 2006; U.S. Provisional Patent Application No. 60/772,609, filed Feb. 9, 2006; U.S. Provisional Patent Application No. 60/772,610, filed Feb. 9, 2006; U.S. Provisional Patent Application No. 60/744,126, filed Apr. 1, 2006; and U.S. Provisional Patent Application No. 60/804,441, filed Jun. 11, 2006, all of which are incorporated herein by reference in their entireties.

### BACKGROUND OF THE INVENTION

1. Field of the Invention

This disclosure generally relates to transporting cargo in a warehouse-like environment, and more particularly, to transport devices having automatic data collection devices.

2. Description of the Related Art

In today's economy, many businesses rely on “just in time” manufacturing. The notion behind just in time manufacturing is that a business may reduce its overhead by having a minimal amount of stock on hand. A problem associated with just in time manufacturing is that the logistics are very complicated. Typically, every supplier in the supply chain must be able to ship necessary components or resources on demand or with very little lead time. Thus, efficient handling of cargo is required. It does a supplier no good to have the desired goods on hand, if the supplier cannot readily ship the desired goods.

Similarly, a manufacturer must be able to efficiently move items from a storage facility to an assembly line before the assembly line runs out of the items. Shutting down an assembly line is very expensive to the manufacturer and is to be avoided. While the manufacturer may have the desired items on hand, the manufacturer needs to be able to locate the desired items in the storage area and transport the desired items to the assembly line in an efficient and timely manner.

Today in a modern warehouse environment, various methods and systems are used to track the locations of items. For example, radio frequency identifier (RFID) devices may be employed to label pallets and/or individual units of cargo such as boxes on a pallet. Forklifts may include RFID antennas and readers for interrogating RFID devices. For example, U.S. Pat. No. 6,669,089 describes a system for tracking assets and a forklift with RFID antennas for interrogating RFID devices on pallets. Similarly, U.S. Pat. No. 7,038,573 describes another system and method for locating items within a controlled area and a forklift with RFID antennas.

Typically, RFID antennas and readers are mounted on forklifts in an ad hoc manner. The RFID antennas and readers are mounted at locations where there is room for them regardless of whether or not the locations are ideal locations for interrogating RFID devices. In addition, cabling for the RFID reader and antennas may be exposed and subject to potential dangers such as snagging.

Among other things, there exists a need for providing automatic data collection devices such as RFID readers and RFID antennas at ideal locations. Similarly, there exists a need for providing antennas such that the antennas do not obscure an operator's field of view. In addition, there exists a need for protecting cables from dangers such as snagging.

### BRIEF SUMMARY OF THE INVENTION

In one aspect, a cargo transportation device having a load backrest comprises a frame having opposed first and second side arms configured to couple to the cargo transportation device, wherein the frame defines a plurality of openings between the first and second side arms; and a plurality of antenna assemblies non-fixedly coupled to the frame, each one of the antenna assemblies are mounted in one of the plurality of openings, the antenna assemblies configured to interrogate RFID devices.

In another aspect, a self-propelled cargo transportation device that lifts and moves cargo comprises a propulsion means for propelling the cargo transportation device; a user control device; a cradle configured to receive the user control device, wherein the user control device is removable from the cradle; an alarm configured to actuate if the cradle has not received the user control device when an operator of the self-propelled cargo transportation device attempts to engage the propulsion means.

In yet another aspect, a self-propelled cargo transportation device that lifts and moves cargo comprises a propulsion means for propelling the cargo transportation device; a lift means for raising and lowering cargo, the lift means coupled to the propulsion means; a cabin for an operator to operate propulsion and lift controls of the cargo transportation device; a load backrest coupled to the lift means; an automatic data collection device configured to interrogate wireless communication devices, the automatic data collection device coupled to the load backrest; a computing device having logic for controlling the automatic data collection device and logic for controlling the lift means and the propulsion means; a display device in communication with the computing device and coupled to the cabin, the display device configured to provide the operator with information from the computing device.

In yet another aspect, an automatic collection device antenna assembly comprises a housing defining a generally hollow interior and an open front face, the front face having a given area; an automatic collection device antenna mounted in the hollow interior of the housing; and a transparent cover coupled to the front face of the housing and covering the automatic collection device, the transparent cover having a size that is greater than the given area of the front face of the housing.

### BRIEF DESCRIPTION OF THE SEVERAL VIEWS OF THE DRAWING(S)

FIG. 1 is a block diagram showing a cargo management/transportation system according to one illustrated embodiment.

FIG. 2 is an isometric view of a cargo transporter having a load backrest according to one illustrated embodiment.

FIG. 3 is an isometric view of a first embodiment of a load backrest according to one illustrated embodiment.

FIG. 4 is an isometric exploded view of a portion of a frame and of the load backrest of FIG. 3 according to one illustrated embodiment.

FIG. 5 is an isometric view of a third embodiment of a load backrest according to one illustrated embodiment.

FIG. 6 is an isometric view of a fourth embodiment of a load backrest according to one illustrated embodiment.

FIG. 7 is an exploded isometric view of an antenna assembly according to one illustrated embodiment.

FIG. 8A is an isometric view of an automatic data collection device mounted to a load backrest according to one illustrated embodiment.

FIG. 8B is a side view of the automatic data collection device of FIG. 8A according to one illustrated embodiment.

FIG. 9 is an isometric view of a cable retainer according to one illustrated embodiment.

FIG. 10 is an isometric view of a cable retainer according to one illustrated embodiment.

FIG. 11 is a block diagram of an automatic data collection sub-system according to one illustrated embodiment.

FIG. 12 is an isometric view of a computing system according to one illustrated embodiment.

FIG. 13 is an isometric view of a portion of a cabin of the cargo transporter of FIG. 2 according to one illustrated embodiment.

FIG. 14 is an isometric view of a portion of a warehouse according to one illustrated embodiment.

### DETAILED DESCRIPTION OF THE INVENTION

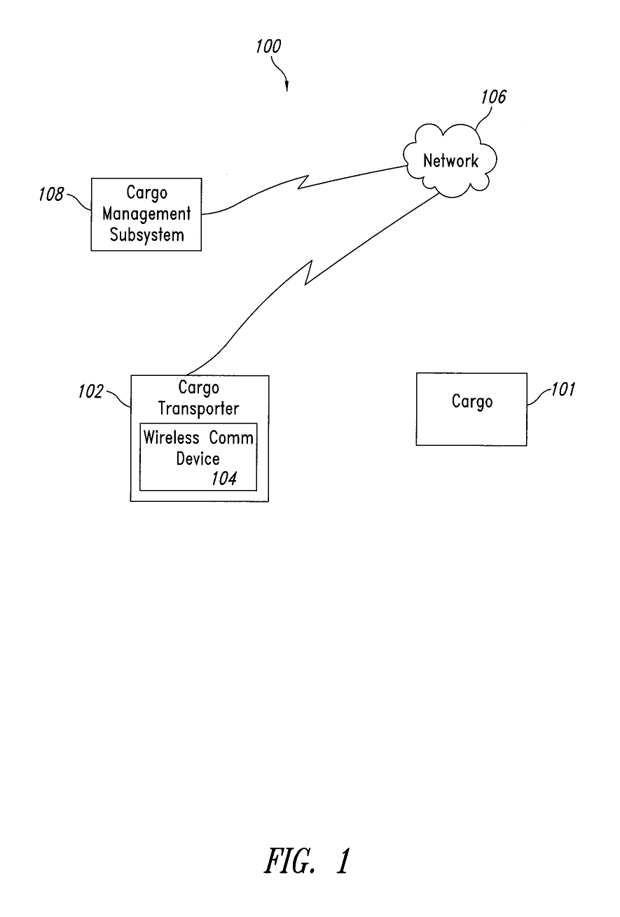

FIG. 1 shows a cargo management/transportation system 100 according to one illustrated embodiment. The cargo transportation system 100 includes a cargo transporter 102 having a wireless communication device 104. The wireless communication device 104 is configured to communicate with a cargo management subsystem 108 via a network 106. The wireless communication device 104 may communicate with the cargo management subsystem 108 using a communication standard such as 802.11. The cargo transporter 102 is configured to move a cargo 101 from one location to another. Typically, the cargo transporter 102 may move the cargo 101 between a location in a warehouse or other cargo holding area, ship, barge, railway car, etc. to a loading dock, or onto a long distance cargo transporter such as a delivery truck. The cargo transporter 102 is normally configured to raise and lower the cargo 101 such that the cargo 101 may be stacked on other cargo and/or placed on and removed from shelves and/or long distance cargo transporters.

Among other things, the cargo management subsystem 108 may provide navigation assistance and inventory control of items such as the cargo 101. Navigation assistance may include providing the cargo transporter 102 with the current location of the cargo 101 and with a destination location for the cargo 101.

### Cargo Transporter

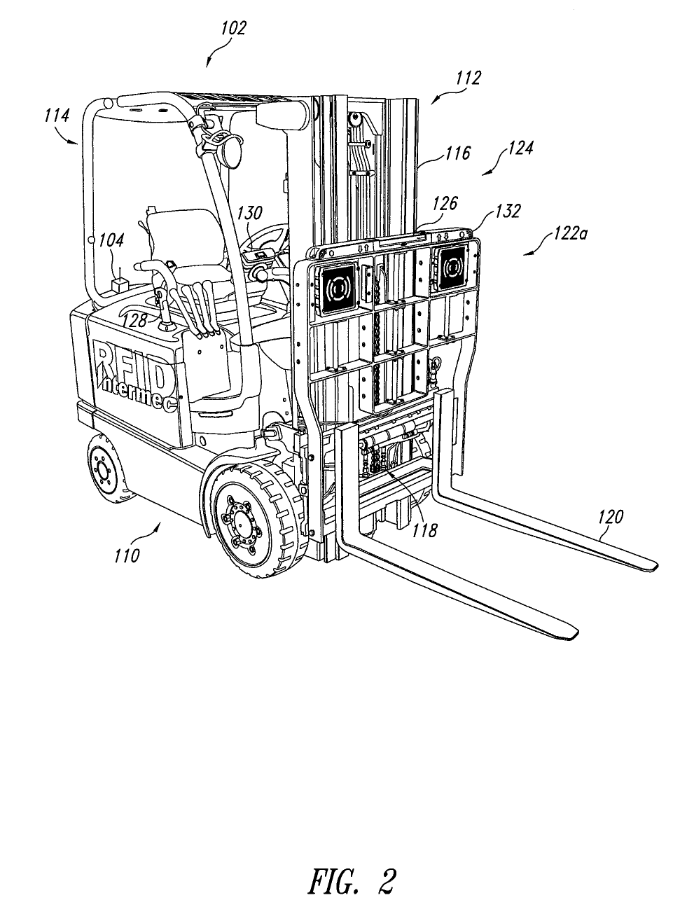

FIG. 2 is an isometric view of an embodiment of the cargo transporter 102. It should be noted that the cargo transporter 102 is illustrated as a motorized forklift merely for the sake of clarity. However, the forklift may be replaced by other mechanical devices for raising and/or transporting cargo such as, but not limited to, a walkie stacker, a rider stacker, tug, crane, etc.

The illustrated cargo transporter 102 includes a truck portion 110, a lift assembly 112, and a cabin 114. The truck portion 110 includes a motor and a drive train for powering and moving the cargo transporter 102 (and cargo) from one location to another. The motor may be powered by fuels such as liquid petroleum gas, gasoline, diesel, or by batteries and/or fuel cells. For the sake of brevity, the truck portion 110 shall not be discussed in detail.

The lift assembly 112 includes a mast 116, a carriage assembly 118, one or more generally L-shaped forks 120, and an adaptable load backrest assembly 122a. The mast 116, carriage assembly 118, and forks 120 are conventional components of a forklift and are not described in detail. The mast 116 is coupled to the truck 110 and to the carriage assembly 118. The carriage assembly 118 is controllably moved vertically along the mast 116 by an operator employing lift assembly controls the cabin 114. The carriage assembly 118 is coupled to the forks and to the adaptable load backrest assembly 122a. For the sake of brevity, the mast 116, carriage assembly 118, forks 120 and mechanisms for raising/lowering/tilting/swiveling the forks 120 are not be discussed in detail.

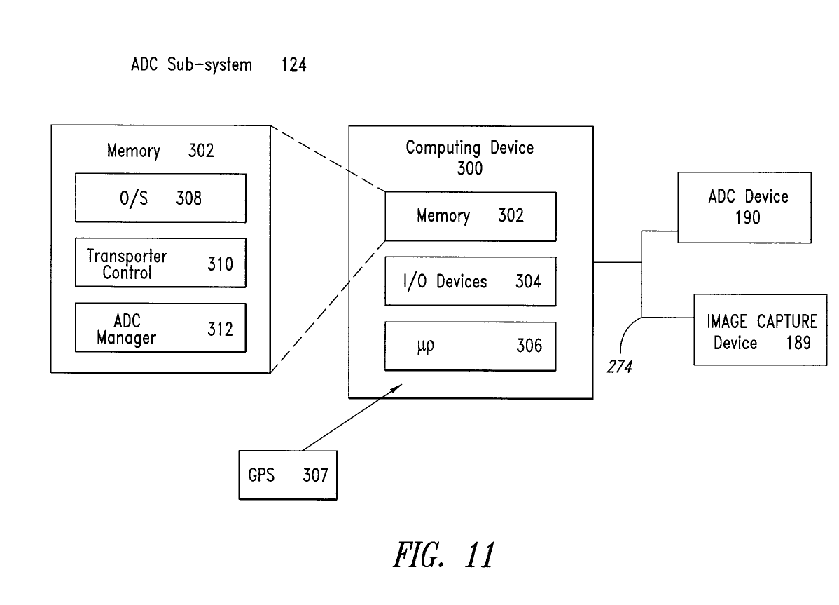

The cargo transporter 102 includes an automatic data collection (ADC) subsystem 124, which includes an automatic data collection (ADC) device assembly 126, an ADC user control device 128, a computing device 300 (see FIG. 11) and a display 130. The ADC system 124 is in communication with the cargo management subsystem 108 via the wireless communication device 104.

Among other things, the operator of the cargo transporter 102 may use the ADC subsystem 124 to, interrogate wireless communication devices such as RFID devices and, in some embodiments, write to wireless communication devices. The operator may use the ADC user control device 128 to, among other things, actuate the ADC device assembly 126, which then may interrogate or write to a wireless communication device. The display 130 may be used for, among other things, providing the operator with instructions and/or directions that may be provided by the cargo management subsystem 108. The display 130 may also be used for, among other things, providing the operator with information related an interrogated wireless communication device.

In the embodiment illustrated in FIG. 2, the ADC device assembly 126 is mounted on the adaptable load backrest assembly 122a. The adaptable load backrest assembly 122a also includes direction indicators assemblies 132.

### Adaptable Load Backrest

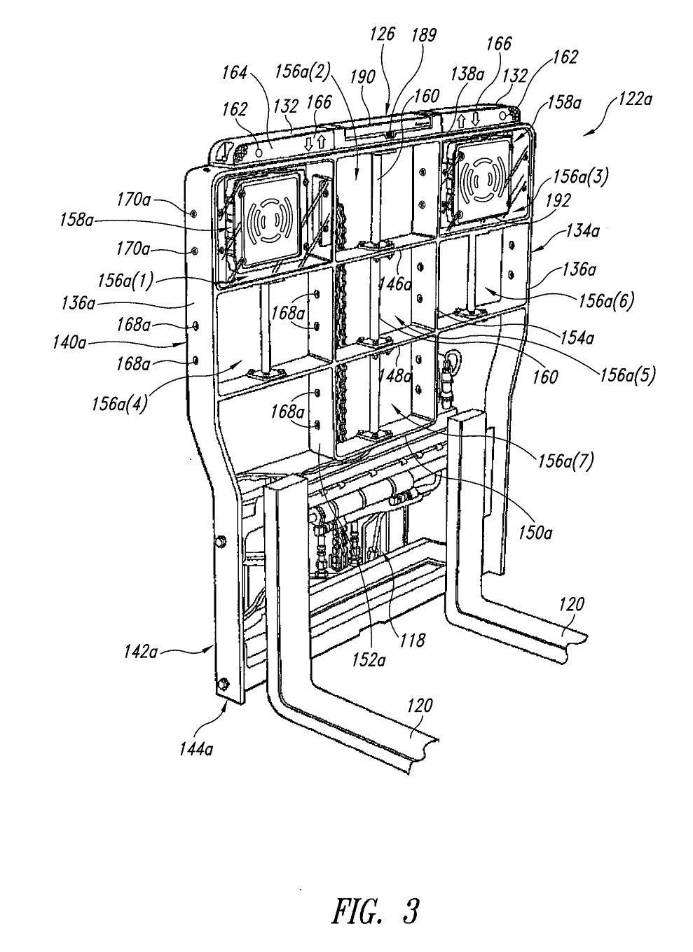

FIG. 3 shows a portion of the lift assembly 112 with the mast 116 and the truck 110 removed for the sake of clarity, according to one illustrated embodiment. The adaptable load backrest assembly 122a includes a frame 134a having side arms 136a and a top cross member 138a extending between the side arms 136a. The side arms 136a form a generally parallel upper region 140a near the top cross member 138a, an inwardly tapered intermediate region and a generally parallel lower region 142a near a bottom 144a of the frame 134a. At the lower region 142a of the side arms 136a, the frame 134a is coupled to the carriage assembly 118. The frame 134a further includes generally aligned cross members 146a, 148a, 150a and generally vertically aligned members 152a, 154a. In the embodiment illustrated, the frame 134a defines seven antenna placement zones, collectively referenced as 156a and individually referenced as 156a(1)-156a(7). The antenna placement zones 156a(1), 156a(3) are shown having antenna assemblies 158a mounted therein.

The adaptable load backrest assembly 122a also includes a number of safety barriers 160. The safety barriers 160 are configured to be removably coupled to the frame 134a. Each one of the safety barriers 160 may be removed from the frame 134a and replaced by an antenna assembly 158a. The safety barriers 160 are made of a rigid tubular material such as steel, aluminum, etc. and, when in operable position, the safety barriers 160 prevent objects from passing through the antenna placement zones 156a that do not have an antenna assembly 158a mounted therein such as the antenna placement zones 156a(2), 156a(3)-156a(7).

In some embodiments, when one of the antenna placement zones 156a does not have an antenna assembly or a safety barrier mounted therein, the antenna placement zone may not comply with regulatory workplace regulations such as regulations promulgated by the Occupational Safety and Health Administration and/or industry practice. Conventional load backrests are configured to prevent 6″×6″×6″ objects from passing through the conventional load backrest.

However, when an antenna assembly 158a or a safety barrier 160 is mounted in an antenna placement zone 156a, then objects having dimensions of 6″×6″×6″ are prevented from passing through such antenna placement zones.

Each one of the antenna placement zones 156a has at least one antenna assembly coupling feature, which may be used to removably couple one of the antenna assemblies 158a thereto. In the embodiment illustrated in FIG. 3, the antenna assembly coupling features are illustrated as holes 168a. In this particular embodiment, the antenna assemblies 158a are coupled into the antenna placement zones 156a(1) and 156a(3) by bolts 170a and complimentary nuts (not shown).

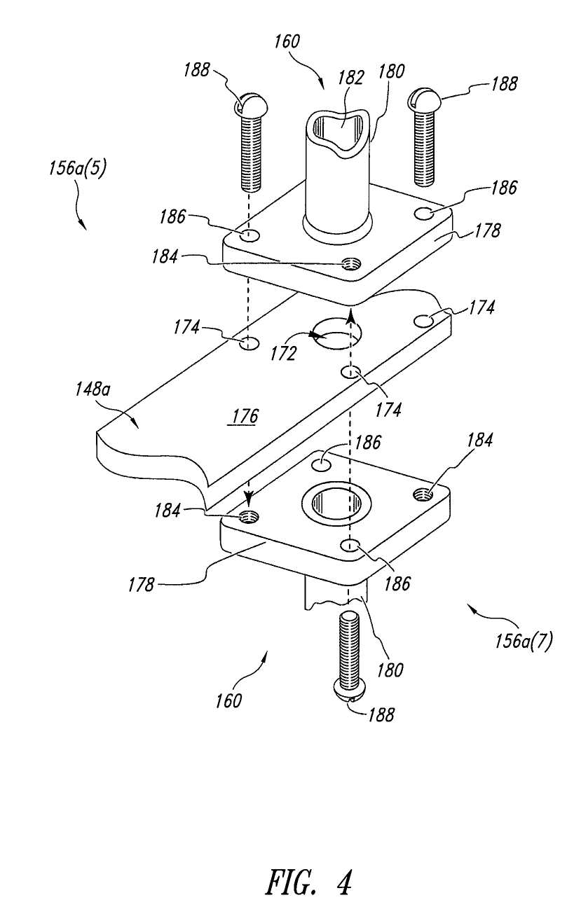

FIG. 4 is an isometric exploded view of a portion of the frame 134a and safety barriers 160. In one embodiment, the antenna placement zones 156a are essentially identically configured such that antenna assemblies 158a and/or safety barriers 160 can be interchanged between respective antenna placement zones. FIG. 4 shows a portion of the antenna placement zone 156a(5) and a portion of the antenna placement zone 156a(7). The following description may apply to each of the antenna placement zones 156a.

The cross member 148a includes a plurality of cable throughways 172, of which only one is shown, and safety barrier coupling features. The cable throughway 172 extends through the cross member 148a such that cables and wiring (not shown) for antenna assemblies 158a, ADC device assembly 126, direction indicator assemblies 132, and for other uses may be passed vertically from one antenna placement zone to the next.

The safety barrier coupling features are illustrated as holes 174, which may be threaded or unthreaded. The holes 174 may extend through the cross member 148a. If the holes 174 are threaded, the threads of the hole may have a first twist direction from a top side 176 of the cross member 148a and the opposite twist direction from a bottom side of the cross member 148a.

The safety barriers 160 include a base 178 and a tube 180. The base 178 has an opening (not shown) that is aligned with the hollow interior 182 of the tube 180. The base 178 includes a plurality of threaded holes 184 and unthreaded holes 186. The safety barrier 160 is configured such that the holes 184, 186 are aligned with the holes 174 and the hollow interior 182 is aligned with the cable throughway 172.

In the embodiment illustrated, the holes 174 may be unthreaded and the upper safety barrier 160 is rotationally offset from the lower safety barrier 160 by 90° such that the unthreaded holes 186 of one of the safety barriers is aligned with the threaded holes 184 of the other safety barrier. Screws 188 are then inserted through the unthreaded holes 186 and holes 174 such that the screws 188 engage the threaded holes 184. Of course, if one of the safety barriers is removed, the other safety barrier may be held in place by having nuts (not shown) engage the screws 188.

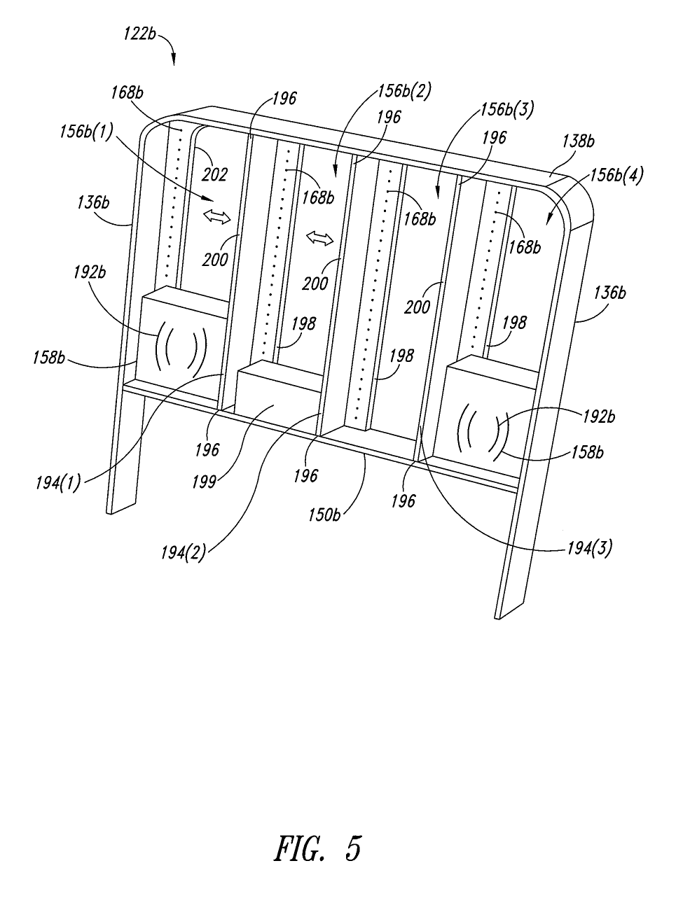

FIG. 5 is an isometric view of another embodiment of an adaptable load backrest assembly 122b. In FIG. 5, various features and components are labeled with a reference numeral and a letter “b.” Such labeled features and components are similar to various features and components shown in FIG. 3 that are labeled with the same reference numeral and the letter “a.” For the sake of brevity, such features and components are not discussed again in detail. In FIG. 5, for the sake clarity, the truck 110, the mast 116, the carriage assembly 118, the ADC device assembly 126, and direction indicator assemblies 132 are not shown.

The adaptable load backrest 122b includes opposed side arms 136b. Top cross member 138b extends between the opposed side arms 136b, as does the bottom cross member 150b. Movable tines, which are collectively referenced as 194 and individually referenced as 194(1)-194(3), extend between the top cross member 138b and the bottom cross member 150b.

In one embodiment, the tines 194 may be removably coupled to the top member 138b and the bottom member 150b by fasteners such as bolts, screws, etc. In another embodiment, cross members 138b and 150b are each configured to allow opposed ends 196 of the tines 194 to be slid in a channel (not shown) and fastened/locked in place. The channel may include stops to restrict the amount of displacement of the tines 194. For example, the stops may be provided such that the maximum distance between adjacent tines (e.g., tines 194(1) and 194(2)) is no more than a safe distance (e.g., 6 inches).

In the embodiment illustrated, the tines 194 are generally T-shaped in cross section having a back member 198 and front member 200 that extends generally outward from the approximate middle of the back member 198. On each side of the front member 200, portions of the back member 198 extend outward and formed thereon are a plurality of antenna assembly coupling features 168b, which are illustrated as holes 168b. The side arms 136b may also have flanges 202. The flanges 202 also include antenna assembly coupling features 168b. In one embodiment, movable tines may also be disposed proximal to the side arms 136b such that the moveable tines may abut the side arms 136b and/or be moved inward toward the center of the adaptable load backrest assembly 122b.

The adaptable load backrest assembly 122b illustrated in FIG. 5 includes four antenna placement zones 156b(1)-156b(4). By moving the tines 194, the antenna placement zones 156b can be configured to accept antenna assemblies 158b and/or other components of varying sizes. The antenna assemblies 158b may include a bracket and/or housing for coupling to the antenna coupling features 168b. Typically, the antenna assemblies 158b may be coupled to the adaptable load backrest 122b via bolts and/or screws (not shown).

In the embodiment illustrated, a power source such as a battery 199 is mounted to the adaptable load backrest assembly 122b. The battery 199 provides electrical power to the antenna assemblies 158b. The battery 199 may be used to power other components/assemblies (not shown) coupled to the adaptable load backrest assembly 122b.

Frequently, cargo transporters 102 repeatedly move the same sort of cargo and/or cargo that is configured in the same fashion. For cargo that has a wireless communication device such as an RFID device, it may be desirable to mount the antenna assemblies 158b onto the adaptable load backrest 122b in particular positions, and it might be desirable to orientate the antenna assemblies 158b in particular directions. Thus, in one embodiment, the antenna assemblies 158b can be orientated in various predetermined directions by interposing spacers (not shown) between the antenna assemblies 158b and the tines 194. The spacers might be cylindrical with a hollow interior such that bolts or screws or other fasteners can be inserted through the spacers. By varying the number of spacers and the locations of the spacers, an end-user would be able to point the antenna assemblies 158b in desired directions.

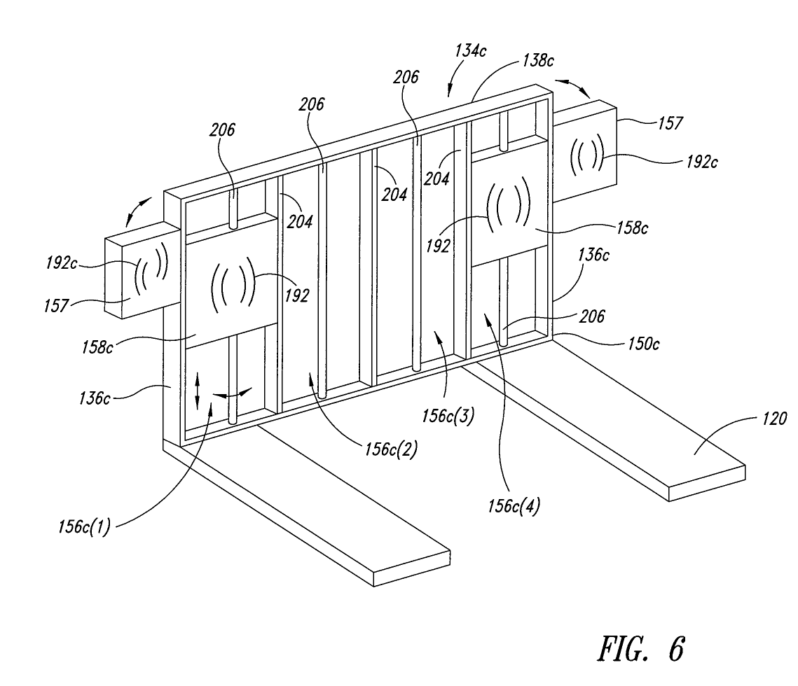

FIG. 6 shows another embodiment of an adaptable load backrest 122c and forks 120. In FIG. 6, various features and components are labeled with a reference numeral and a letter “c.” Such labeled features and components are similar to various features and components shown in FIG. 3 that are labeled with the same reference numeral and the letter “a.” For the sake of brevity, such features and components are not discussed again in detail. In FIG. 6, for the sake clarity, the truck 110, the mast 116, the carriage assembly 118, the ADC device assembly 126, and direction indicator assemblies 132 are not shown.

The frame 134c includes side arms 136c with top cross member 138c and bottom cross member 150c extending therebetween. Vertical members 204 extend between the top member 138c and bottom member 150c.

The adaptable load backrest assembly 122c has four antenna placement zones 156c(1)-156c(4). The antenna placement zones 156c(1), 156c(4) have shafts 206 extending between the cross members 138c and 150c. In some embodiments, the shafts 206 are removable. In the case where the shafts 206 are removable, the shafts 206 in the antenna placement zones 156c(2) and 156c(3) might be removed so as to reduce the amount of obstruction to the operator's field of view.

Slideably mounted on the shafts 206 are antenna assemblies 158c. The antenna assemblies 158c may also be rotatably mounted on the shafts 206. Such a configuration allows the end user to position the antenna assemblies 158c at a desired location and desired orientation.

In one embodiment, the position and orientation of the antenna assemblies 158c may be controlled by the computing device of the cargo transporter 102 and/or by the operator of the cargo transporter via the ADC user control 128. For example, the shafts might be controllable jack screws that enable the antenna assemblies 158c to be vertically positioned.

In some embodiments, the members 204 and shafts 206 might extend horizontally between the side arms 136c such that the antenna placement zones 156c extend horizontally. In that case, the antenna assemblies 158c may be moved horizontally between the side arms 136c and tilted up/down.

In some embodiments, the adaptable load back rest assembly 122c has antenna assemblies 157 mounted onto the side arms 136c. The antenna assemblies 157 are configured to rotate about an axis such that the antenna assemblies 157 can be moved between a side orientation and a front orientation. In front orientation, the antenna assemblies 157 extend generally outward from the side arms 136c. In side orientation, the antenna assemblies 157 extend generally backwards, i.e., in the general direction of the truck 110. In some embodiments, the antenna assemblies 157 are controlled by the ADC subsystem 124 such that the antenna assemblies 157 automatically flip to their front orientation when actuated and automatically flip back to their side orientation when not being used. Typically, the antenna assemblies 157 are moved to their side orientation prior to the cargo transporter 102 moving.

In some embodiments, the antenna assemblies 157 may be used when positioned in the side orientation. The antenna assemblies 157 may be used to interrogate RFID devices, or the like, which may be located on pallets, shelves, cargo, etc. By using the antenna assemblies 157 while in the side orientation, the operator of the cargo transporter 102 can interrogate an RFID device, or the like, without having to point the cargo transporter at the RFID device. Thus, when searching for a specific item, the operator may simply move the cargo transporter up/down an aisle and interrogate RFID devices without stopping and orientating the cargo transporter at each of the RFID devices, thereby increasing the speed at which the operator may locate the specific item.

### Antenna Assembly

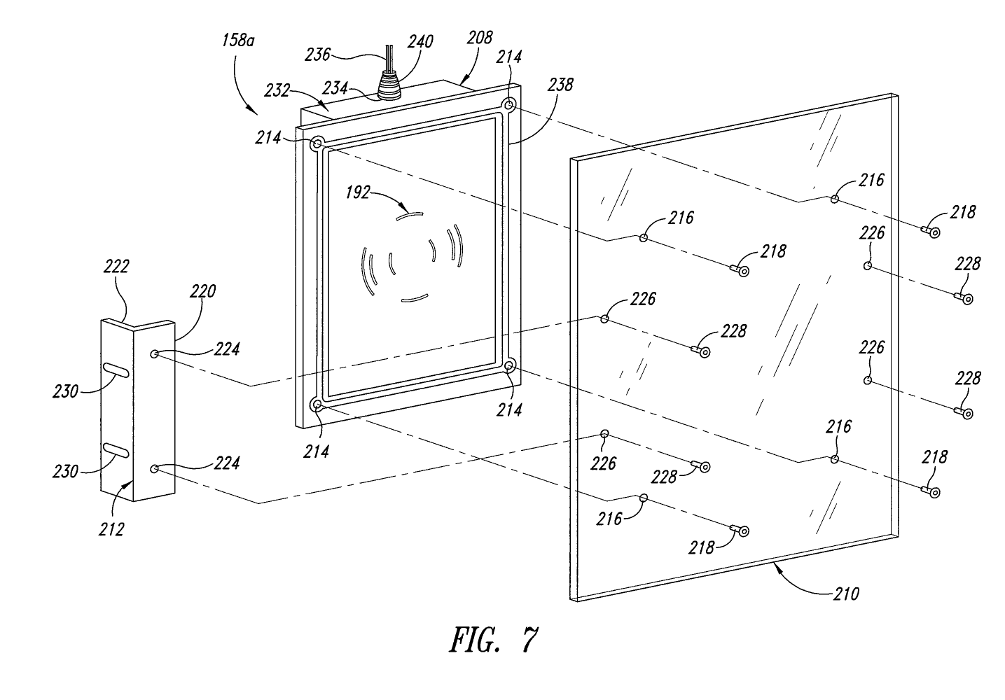

FIG. 7 is an exploded isometric view of an antenna assembly 158a. The antenna assembly 158a includes a housing 208, a plate 210, and a pair of coupling brackets 212 of which only one is shown. The housing 208 is made from a rigid material, for example, metal. The housing 208 has a generally hollow interior that receives the antenna 192. The housing 208 defines a number of holes 214.

The plate 210 defines a first number of holes 216. In operable position, the holes 216 of the plate 210 and the holes 214 of the housing 208 are aligned and fasteners 218, such as screws, bolts, etc., may be used to removably couple the plate 210 to the housing 208.

Typically, the plate 210 is larger than the housing 208 and shaped to be received by the antenna placement zone 156a. The plate 210 may be shaped to cover a predetermined portion of the antenna placement zone 156a and/or the entire placement zone 156a. Thus, the plate 210 may form a protective barrier that prevents objects from passing through the antenna placement zone 156a. In some embodiments, the plate 210 is transparent and consequently does not reduce the field of view of the operator of the cargo transporter 102. The plate 210 may be formed from an acrylic or a polycarbonate.

The coupling bracket 212 is made from a rigid material such as metal and is generally L-shaped having a first leg 220 and a second leg 222. The first leg 220 defines a number of holes 224. The second leg defines a number of slots 230. In operable position, the holes 224 are aligned with the holes 226 formed in the plate 210. The plate 210 and coupling bracket 220 are coupled by fasteners 228, such as screws, bolts, etc.

The coupling bracket 212 is fastened to the sidearm 136a via bolts 170a(see FIG. 3), which extend through the holes 168a and through the slots 230. Nuts (not shown) are threaded onto the bots 170a to fasten the coupling bracket 212 to the sidearm 136a.

The slots 230 are oversized with respect to the bolts 170, thereby allowing the coupling bracket 212 to be moved up and down and front and back with respect to the bolts 170a when the nuts are loose. Thus, the free play between the coupling bracket 212 and the bolts 170a allows the antenna housing assembly 158a to be positioned in a desired orientation such as a straight ahead or tilted in a desired direction.

The housing 208 includes a top surface 232 having a cable passageway 234 formed therein. The cable passageway 234 extends to the hollow interior of the housing 208. In some embodiments, the cable passageway 234 may include a cable strain relief fixture 240. Cables/wiring 236 pass into the housing 208 via the cable passageway 234. The cables 236 then extend to a cable throughway formed in the top cross member 138a.

In some embodiments, the housing 208 has multiple cable passageways (not shown). The multiple cable passageways may allow cables from other components, such as another antenna, to pass through the housing 208. The multiple cable passageways also allow for easier cable management. For example, the multiple cable passageways may be formed on multiple surfaces of the housing 208 such as the top surface 232 and opposed bottom surface, a right surface, and a left surface thereby allowing the housing 208 to receive cables 236 from any direction.

In some embodiments, a gasket 238 is placed between the plate 210 and the housing 208. With the gasket 238 in place, the seal between the plate 210 and the housing 208 is sufficient to prevent dust, dirt, and other debris from entering the housing 208. The plate 210 and/or housing 208 may include a perimeter recess signal and be shaped to partially receive the gasket 238.

### ADC Device Assembly

Referring back to FIG. 3, the ADC device assembly 126 includes an image capture device 189. The image capture device 189 may be configured to take video images and/or still images. The image capture device 189 may be controllable by the operator of the cargo transporter 102 and/or by the computing device of the cargo transporter 102. The images from the photographic device 189 may be downloaded to the cargo management subsystem 108 and stored therein. The stored images may be used to provide documentary evidence of transactions and events related to the operation of the cargo transporter 102. For example, the images may record the condition of cargo picked up by the cargo transporter 102 and the condition of the cargo when the cargo is left by the cargo transporter 102. Similarly, the images may record where the cargo was picked up and where the cargo was dropped off. Image capture may be automatically triggered. For example, image may automatically be captured in response to the presence or absence of a wireless identification device, such as an RFID transponder or tag. For example, an image may be automatically captured upon detection of a new RFID tag. A subsequent image may be automatically captured upon loss of detection of the RFID tag. Additionally, or alternatively, images may be automatically captured in response to a position of the cargo transporter 102 in the warehouse and/or a position of some portion of the cargo transporter (e.g., forks 120) relative to some other portion of the cargo transporter 102. For example, images may be automatically captured each time the forks 120 are in a raised position and/or in a lowered position. For example, image may be automatically captured each time the cargo transporter arrives at one or more selected positions (e.g., pickup and/or drop off locations).

In addition, in some embodiments, the video functionality of the image capture device 189 might be used by the operator of the cargo transporter 102 in real-time. Images (still and/or video) from the image capture device 189 can be viewed by the operator of the cargo transporter 102 on the display 130 (see FIG. 2). When the operator's field of view is obstructed, the operator of the cargo transporter 102 can see where the cargo transporter 102 is headed by viewing images from the image capture device 189 on the display 130. Similarly, the operator might use the image capture device 189 and display 130 to view shelves and cargo that are out of the operator's field of view. This will enhance the productivity of the operator by making the loading and unloading of cargo, which is outside of the operator's natural the field of view, visible on the display, and therefore, easier, faster, and safer. Such images may additionally or alternatively be used by security personnel.

In one embodiment, the ADC device assembly 126 includes an ADC device 190, such as an RFID reader. The ADC device 190 is in communication with the antenna assemblies 158a and with the ADC subsystem 124. The ADC device 190 may be actuated by the operator of the cargo transporter 102 via the ADC user control 128. Each one of the antenna assemblies 158a includes an antenna 192 such as an RFID antenna. For the purposes of clarity, the ADC device 190 and the antennas 192 are described herein as an RFID reader and RFID antennas, respectively, but such description is non-limiting.

In one embodiment, the ADC device assembly 126 is designed with a low profile shape so as to minimize obstruction of the field of view of the operator. By mounting the ADC device assembly 126 to the top cross member 138a of the adaptable load backrest 122a, the ADC device assembly 126 does not interfere with the placement or potential placement of antenna assemblies. The thin size of the ADC device assembly 126 ensures that the ADC device assembly will not interfere with either the movement of the lift or the placement of cargo. This design reduces installation costs by establishing a standard location to mount the ADC device assembly and eliminating the costly trial and error exercise that often happens today when an ADC device is mounted to a conventional load backrest.

The RFID antennas 192 are configured to interrogate RFID devices, which may be located at various locations such as on pallets, various fixed locations such as on shelves, floors, walls, portholes, etc., and/or on cargo. The RFID reader 190 and the RFID antennas 192 may also be configured to write to RFID devices. In one embodiment, the RFID reader 190 may be in wireless communication with the computing device 300 of the cargo transporter 102 and/or with the ADC user control 128. Such wireless communication may be via an interface such as BLUETOOTH®. In addition, in one embodiment, the RFID reader 190 and/or RFID antennas 192 might be electrically powered via a power source such as a battery (not shown) coupled to the adaptable load backrest 122a. Alternatively, batteries might be included in the ADC device assembly 126 and/or the antenna assemblies 158a. It should be noted that the image capture device 189 might also be in wireless communication with the computing device 300 of the cargo transporter and/or may also be battery powered.

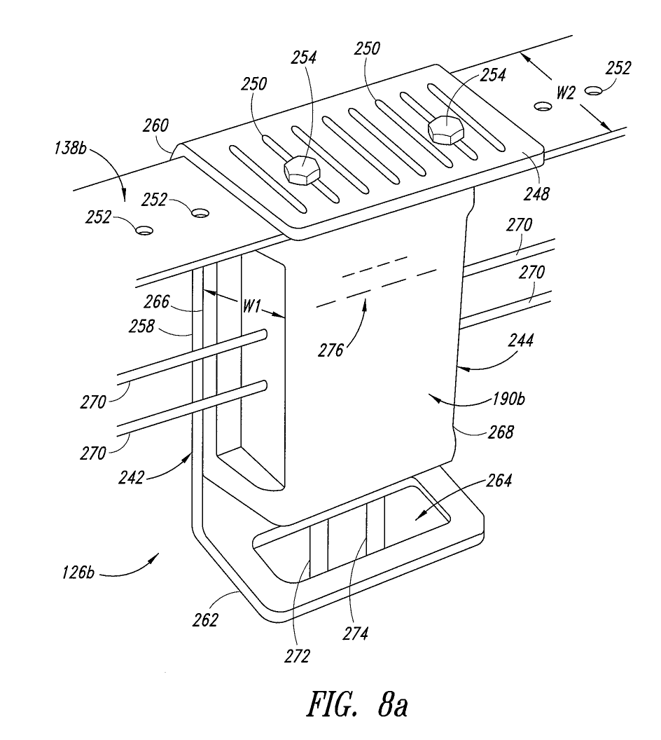

FIGS. 8A and 8B show another embodiment of the ADC device assembly 126b mounted to the top member 138b of the adaptable load backrest 122b. For the sake of clarity, the ADC device assembly 126b was not shown in FIG. 5.

The ADC device assembly 126b includes an ADC device 190b and an ADC mounting bracket 242. The ADC device 190b includes a housing 244 that is coupled to the ADC bracket 242 via fasteners, such as screws 246, which are received by threaded holes in the housing 244.

In the embodiment illustrated, the ADC bracket 242 has an upper flange 248 with slots 250 formed therethrough. The top cross member 138b has a number of holes 252 formed therethrough. The ADC bracket 242 is coupled to the top cross member 138b via fasteners, such as bolts 254 and complimentary nuts 256. The bolts 254 extend through the slots 250 and the holes 252, and the nuts 256 are threaded onto the bolts 254.

The ADC bracket 242 includes a frame section 258, which is recessed back from a lip section 260. The frame section 258 extends downward, and a bottom section 262 extends rearward, i.e., toward the truck 110. The bottom section 262 includes a cable throughway 264.

The housing 244 has a load side face 266, which is coupled to the frame 258 via fasteners 246, and an opposed operator side face 268. Together, the load side face 266 and the operator side face 268 define a housing width W1. The cross member 138b defines a width W2, which is greater than the housing width W1. Because the frame section 258 is recessed from the lip section 260, the housing 244 is also recessed and may be entirely underneath the cross member 138b. Installing the ADC device 190b underneath the cross member 138b such that the ADC device 190b is entirely underneath the cross member 138b provides greater protection for the ADC device 190b than if a portion of the ADC device 190b extends out from underneath the cross member 138b.

The antenna assemblies 158b could also be mounted to the bracket 242 and the antenna assemblies 158b could be mounted completely within the frame 134 of the adaptable load backrest 122b. Alternatively, the ADC device 190b and/or the antenna assemblies 158b might also be configured to mount to the frame 134 of the adaptable load backrest 122b such that a portion extends outward from the frame 134 toward the truck 110. Recessing the antenna assemblies 158b and/or the ADC device 190b backward from the load side protects them from being damaged by cargo on the forks 120.

Cables 270 extend outward from the housing 244. The cables 270 extend to the antenna assemblies 158b. Cables 272 and 274 extend downward from the housing 244 through the cable throughway 264 of the bottom section 262. The cables 272 and 274 may be connected to the truck 110. The cable 272 may communicate power to the ADC device 190b, and the cable 274 may provide communications with the computing device 300 of the ADC subsystem 124.

In some embodiments, the ADC device 190b may be powered by a power source located on the adaptable load backrest 122b. Thus, in some embodiments, the cable 272 extends to the power source. Similarly, in some embodiments, the ADC device 190b may include a battery. Furthermore, in some embodiments the ADC device 190b may be in wireless communication with the computing device 300. Thus, in some embodiments, one or more of cables 272 or 274 might not be needed.

The operator side face 266 includes a plurality of status indicators 276. The status indicators 276 are configured to convey status information for the ADC device 190b. Status information may include, but is not limited to, read status, write status, and idle status. The status indicators 276 are configured to be viewable by the operator of the cargo transporter 102.

### Direction Indicator Assembly

Referring back to FIG. 3, the direction indicator assemblies 132 have lights 162 disposed on a front side 164 and on an opposed rear side (not shown). The lights 162 are controlled by the computing device 300 of the cargo transporter 102. The front lights 162 enable people in front of the cargo transporter 102 to determine the path of the cargo transporter 102. The rear lights (not shown) are visible to the operator of the cargo transporter 102. The lights 162 provide the operator of the cargo transporter 102 with visual stimuli indicating, among other things, a direction that the cargo transporter 102 is supposed to go, proximity to a desired location, and cargo location. The rear lights (not shown) can be easily used to communicate directions to the operator using a predetermined code. For example, if the lights on both the right side direction indicator assembly and the left side direction indicator assembly are in a state, e.g., on/off, that state represents that the cargo transporter 102 should proceed in a straight direction. Changing the state of the lights, e.g., from on/off to off/on, may represent that the cargo transporter 102 should stop. The lights 162 might also flash on/off to indicate the proximity to a desired direction. Similarly, the direction indicator assemblies 132 might include lights 162 of different colors, which can be used to communicate information to the operator and/or persons in the vicinity of the cargo transporter 102.

The direction indicator assemblies 132 may also include location indicator lights 166. The location indicator lights 166 may be used to provide the operator with an indication of whether to raise or lower the forks 120. For example, if the desired cargo is located on a raised platform, e.g., shelf, the location indicator lights 166 would indicate that the forks 120 should be raised. The location indicator lights 166 may change state when the forks are at an appropriate height.

In some embodiments, the direction indicator assemblies 132 can be disposed on the side arms 136a. In such an embodiment, the direction indicator assemblies 132 may include lights that are visible to the operator of the cargo transporter 102 and visible to people who are in front of the cargo transporter 102. In some embodiments, the direction indicator assemblies 132 may be disposed on the backside of the adaptable load backrest 122a, i.e., the side facing toward the operator of the cargo transporter 102, such that the direction indicator assemblies 132 are visible to the operator of the cargo transporter 102.

### Cable/Wire Management

In some embodiments, the cargo transporter 102 includes components and/or features for providing proper cable/wire management. Proper cable/wire management includes protecting cables and wires, routing cables and wires such that the cables and wires are not snagged on objects, and routing cables and wires such that they do not interfere with the operator's field of view and/or impede the motion of the operator.

Referring back to FIGS. 3 and 4, cables and other wiring may be passed to any antenna placement zone 156a via the safety barriers 160, and, if necessary, by the ADC device assembly 126, the direction indicator assemblies 132, and antenna assemblies 158a. For example, wiring may be run from the antenna placement zone 156a(4) to the antenna placement zone 156a(1) via a cable throughway 172 that extends therebetween, through or along the antenna assembly 158a located in the antenna placement zone 156a(1), to the direction indicator assembly 132 thereabove via another cable throughway 122 in the top cross member 138a, through, under or around the direction indicator assembly 132 and the ADC device assembly 126 to another cable throughway 172 to the antenna placement zone 156a(2), and then through the antenna placement zones 156a(2), 156a(5), and 156a(7) via the safety barriers 160 and cable throughways 172, and then out a cable throughway 172 in the cross member 150a. Thus, the cables and the wiring for components coupled to the adaptable load backrest 122a may be protected via the safety barriers 160a. After exiting the adaptable load backrest 122a, the cables and wiring may be fed into a protective conduit (not shown) running to the truck 110 of the cargo transporter 102.

For some adaptable load backrests, such as the embodiment illustrated in FIGS. 5, cables and wiring for antennas and other components affixed to the adaptable load backrest 122b may be fed through conduit (not shown) on the back side of one or more of the movable tines 194. Alternatively, fasteners such as twist ties, zip ties, re-bendable prongs, etc., may be employed to releasably hold cables and wiring in place. Similarly, the adaptable load backrest 122c may also include conduit, twist ties, zip ties, re-bendable prongs, etc. for releasably holding cables in a desired location.

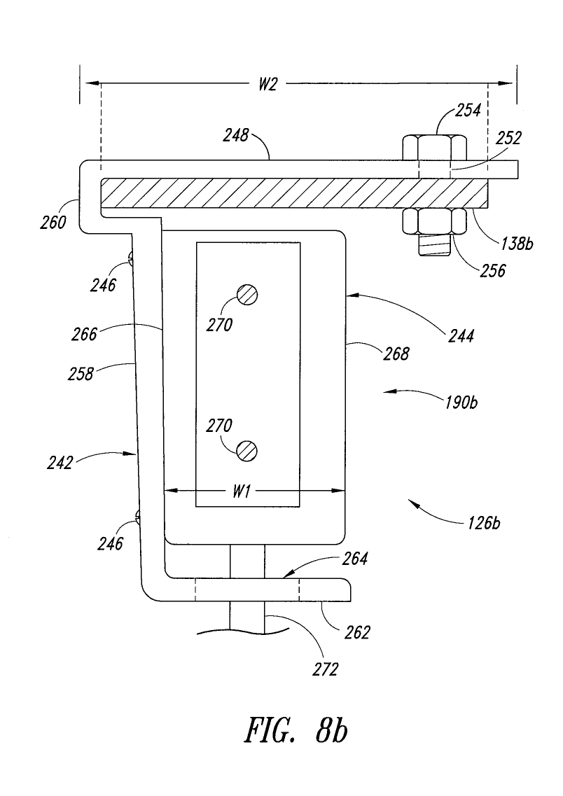

FIG. 9 shows an embodiment of a cable retainer 278. The cable retainer 278 is mounted to a post 280 which is typically part of the truck 110. The cable retainer 278a may also be mounted to a portion of the frame 134. The cable retainer 278 includes a rigid base 282, a locking cap 284, and a cable cap 286. The base 282 and the locking cap 284 are configured to removably couple to the post 280. The cable cap 286 is removably coupled to the base 282 and defines notches 288, which extend through the cable cap 286. Wiring/cables 290 extend along the notches 288 between the cable cap 286 and the base 282. The cable cap holds the cable/wiring 290 in position.

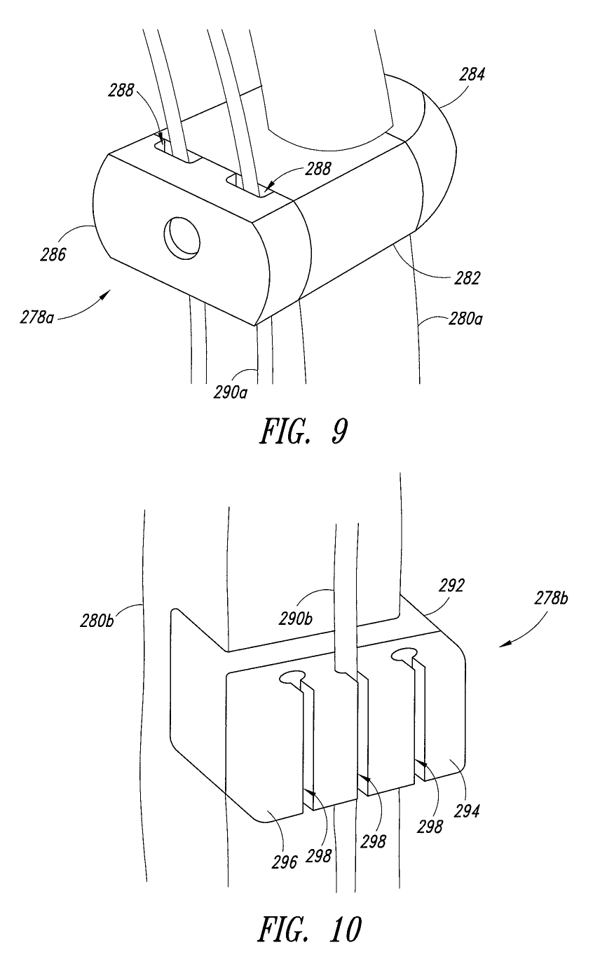

FIG. 10 shows a second embodiment of a cable retainer 278b. The cable retainer 278b is mounted to a post 280b. The cable retainer 278b includes a bracket 292 and a cable coupler 294. The bracket 292 may be magnetized or include a magnet such that the cable retainer 278b can be magnetically coupled to the post 280b and/or to the adaptable load backrest 122. Alternatively, a strap (not shown) or other fastener may be used to couple the bracket 292 to the post 280b. The cable coupler 294 is formed from a deformable material such as an elastomer and has a face 296 with slots 298 formed therein. Each one of the slots 298 is configured to receive a cable such as cable 290b. The slots 298 hold the cable in position.

### ADC Subsystem

Referring to FIG. 11, the ADC subsystem 124 includes a computing device 300, the ADC device 190, and the image capture device 189, which may be optional. The computing device 300 may be in wireless communication with the ADC device 190 and the image capture device 189 via a protocol such as BLUETOOTH®. Alternatively, the computing device 300 may be in direct or wired communication with one or both of the ADC device 190 and the image capture device 189 such as cable 274. The computing device 300 includes a memory 302, input/output (I/O) devices 304, and a processor 306. Among other things, the processor 306 executes programs/software stored in the memory 302.

The I/O devices 304 include keyboards, ADC user control 128, display 130, wireless interface devices for providing wireless communication conforming to protocols such as BLUETOOTH® and 802.11, USB interfaces, keypads, touch screens, scroll knobs, push buttons, etc. Among other things, the I/O devices 304 enable the operator to enter data into the computing device, select menu options, control the operation of the ADC device, and control the operation of the image capture device 189.

The processor 306 is a hardware device for executing software, particularly that stored in memory 302. The processor 306 can be any device for executing software instructions, for example, an Intel X scale processor. Non-limiting examples of processor devices include microprocessors, application-specific integrated circuits (ASIC), and field programmable gate arrays (FPGA). The processor 306 executes the software stored in the memory 302. Program modules or software can be stored in the memory 302 such as an operating system 308, one or more application programs such as cargo transporter control 310 and ADC management 312. The cargo transporter control program module 310 includes instruction sets for controlling conventional operations of the cargo transporter 102. The ADC management program module includes instruction sets for managing the image capture device 189 and the ADC device 190, and may include instruction sets for communicating with the cargo management subsystem 108. In addition, the ADC management program module 312 includes instruction sets for providing direction control to the operator of the cargo transporter 102.

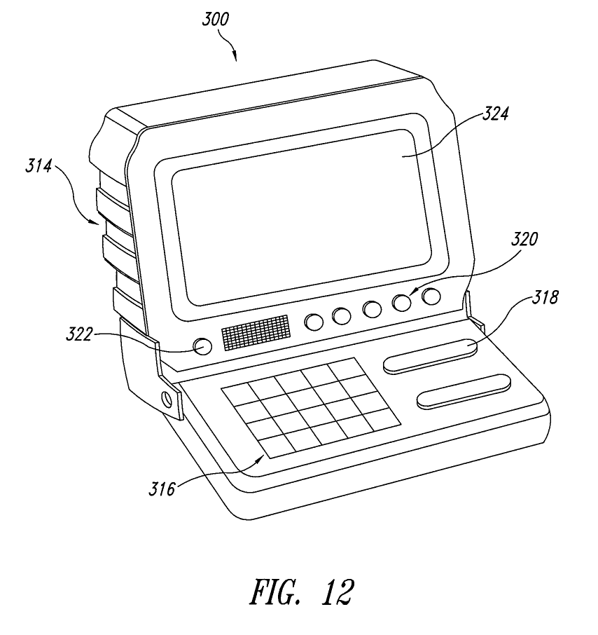

In the embodiment illustrated in FIG. 12, the computing device 300 includes or is communicatively coupled to a Global Positioning System (GPS) device 307. The GPS device 307 may be used to determine the position of the cargo transporter 102. The computing device 300 may provide the position of the cargo transporter 102 to the cargo management system 106 via the wireless communication device 104.

FIG. 12 shows a computing device 300 according to one illustrated embodiment. The computing device 300 includes a housing 314 which is typically constructed from a rigid material such as magnesium. The housing 314 is preferably sealed against dust and moisture and may have an ingress protection rating of IP66 or above.

The computing device 300 includes a keypad 316 and ADC control buttons 318. The operator may use the keypad 316 to, among other things, input information. The ADC control buttons 318 may be used for, among other things, actuating the ADC device 190 and/or the image capture device 189.

The computing device 300 includes control buttons 320. The control buttons 320 may include a power button, a volume button, a display backlight brightness button, and a display zoom button, among others. The computing device 300 also includes a headset jack 322 for receiving a complimentary jack for a headset worn by the operator.

The computing device 300 includes a display device 324. In some embodiments, the display device 324 may be heated, which may protect the display device 324 from detrimental effects due to extreme variations in temperature. In some embodiments, the display device 324 may be a touch-sensitive screen for allowing an operator to input information. Among other things, the display device 324 may be used to provide the operator of the cargo transporter 102 with information regarding directions, pick up locations, drop off locations, ADC read information (e.g., good/bad read, good/bad write), provide alerts such as picking up wrong cargo, dropping off cargo at wrong location, etc.

The computing device 300 may be fixedly coupled to the cargo transporter 102. Alternatively, the computing device 300 may be removably coupled to the cargo transporter 102. In some embodiments, the cargo transporter 102 may include a docking port for receiving the computing device 300. The cargo transporter 102 may be configured to provide an alarm such as an audible alarm if the operator of the cargo transporter 102 attempts to move the cargo transporter 102 without having the computing device 300 mounted in the docking port. The alarm may prevent an operator from accidentally leaving the computing device 300 behind when the operator is moving the cargo transporter 102 to a different location. In some embodiments, the computing device 300 may be a tablet type computing device.

### Transporter Cabin

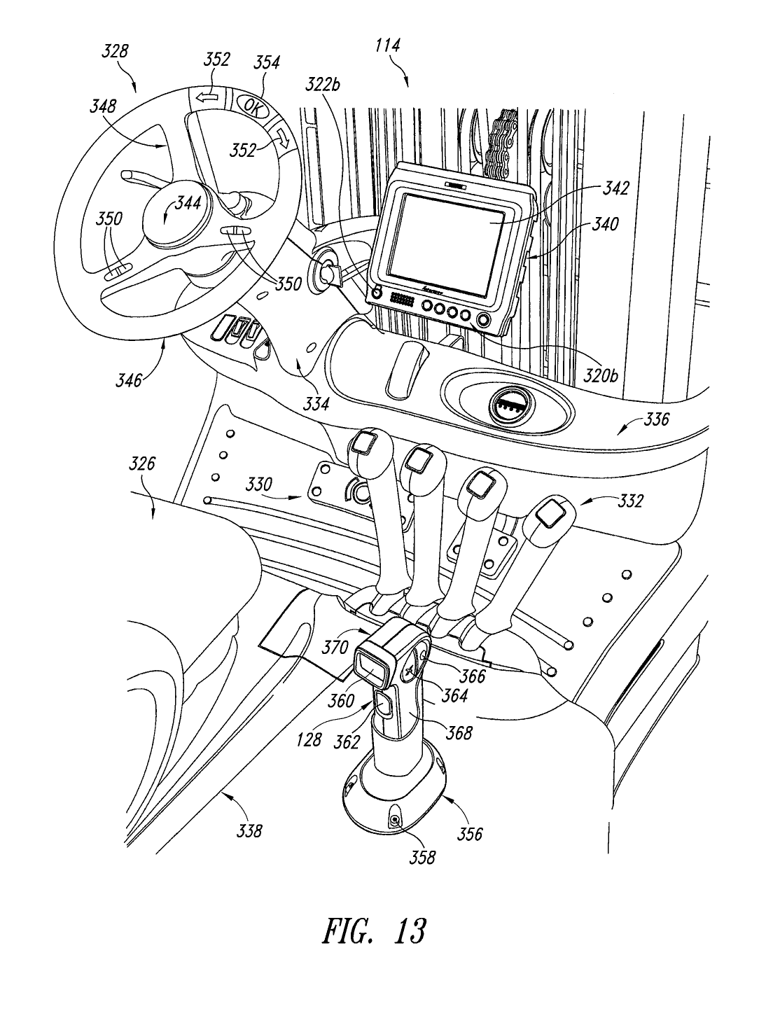

FIG. 13 shows a portion of the cabin 114 of the cargo transporter 102. Some portions of the cabin and controls therein that are standard to a conventional cargo transporter 102 are not discussed in detail.

An operator of the cargo transporter 102 sits on a seat 326 when operating the cargo transporter 102 and controls the cargo transporter 102 via a steering wheel 328, gas/brake pedals 330, and lift assembly control levers 332, among other control subsystems. The cabin 114 also includes a steering wheel column 334 on which the steering wheel 328 is mounted, a dashboard 336, and a cowling 338, which is adjacent to the seat 326.

In the embodiment illustrated, a computing device 340 having a display device 342 is mounted to the steering column 334 via an arm 343. The computing device 340 may be mounted such that the field of view of the operator is not blocked by or obscured by the computing device 340 and such that the display device 342 is readily apparent/viewable to the operator of the cargo transporter 102. If the steering column 334 is a tilt steering column, the computing device 340 moves with the steering column 334. Thus, the computing device 340 does not impede the operator's ingress and egress. In addition, the computing device 340 may be mounted to the steering column 334 such that the computing device 340 does not impede the operator's ability to control the cargo transporter 102. In some embodiments, the computing device may be mounted on the dashboard 336, and in yet other embodiments, the computing device 340 may be mounted in the dashboard 336 such that the display device 342 is viewable. In some embodiments, the computing device 340 may be essentially identical to the computing device 300 illustrated in FIG. 12 except that the computing device 340 does not include the keypad 316 and the ADC control buttons 318. In the embodiment illustrated in FIG. 13, the computing device 340 includes control buttons 320b and headset jack 322b.

In some embodiments, the cabin 114 may include one or more display devices. For example, a movable display device (not shown) may be configured between a storage position and a viewable position. The storage position of the movable display device may be above the operator's field of view, and the viewable position would be within the operator's field of view. The movable display device may be a projection-type display device. The movable display device may be configured to be viewable by the operator when the operator is outside of the cabin 114. The movable display device may be large (e.g., more than 12 inches in diagonal length) such that the operator may view the information displayed by the display device when the operator is outside of the cabin 114.

In some embodiments, the cabin 114 may include a display device affixed to a post of the cabin 114. The display device affixed to the post may be movable such that the operator may move the display device out of the operator's field of view. Yet other embodiments may employ a heads up display device, for example, one which displays information on an otherwise transparent screen between the operator and the lift assembly 112.

### Steering Wheel

The steering wheel 328 may include a plurality of ADC controls. For example, the steering wheel 328 includes a hub 344, a rim 346, and arms 348 extending between the hub 344 and rim 346. The arms 348 include buttons 350 that may be used to control various aspects of the ADC subsystem 124. For example, the buttons 350 may control functions of the ADC device 190 such as, initiate read, submit read data, cancel, clear, etc. In some embodiments, the buttons 350 may be programmable such that the operator may define functions/settings for the buttons 350.

The steering wheel 328 may also include direction indicators 352 and read indicator 354 on the rim 346. The direction indicators 352 may be illuminated to signal the operator to turn left or right. The read indicator 354 may be illuminated when the ADC device 190 successfully reads a wireless device such as an RFID device.

The ADC user control 128 is received by a cradle 356, which is mounted to the cowling 338 proximal to the seat 326 such that the cradle 356 is ergonomically positioned and readily accessible to the operator of the cargo transporter 102. The cradle 356 may be fixed to the cowling 338 via fasteners 358. In some embodiments, the cradle 356 is connected to subsystems of the cargo transporter 102 such as an electrical/ignition subsystem and/or the computing device 340. The cradle 356 may include electrical contacts (not shown), which are connected to the electrical/ignition subsystem of the cargo transporter 102, to charge one or more batteries in the ADC user control 128. In addition, the cradle 356 may include a switch or a contact that actuates an alarm, or prevents the cargo transporter 102 from being moved, when the operator attempts to move the cargo transporter 102 without the ADC user control 128 being in the cradle 356.

In some embodiments, the cradle 356 is magnetically coupled to the cargo transporter 102 such that the operator of the cargo transporter 102 may position the cradle 356 at a convenient and/or ergonomic location of the operator's choice.

### Steering Wheel

The ADC user control 128 may be removable from the cradle 356 such that the operator of the cargo transporter 102 may use the ADC user control 128 when the operator is outside of the cabin 114. The operator of the cargo transporter 102 may also use the ADC user control 128 when the operator is inside the cabin 114.

The ADC user control 128 includes an ADC reader such as an optical reader and/or laser reader that may be used to scan symbologies such as bar codes. In one embodiment, the operator may orientate the ADC user control 128 such that a window 360 is pointed in the general direction of a target. Light from the target is received at the window 360. The operator may actuate the ADC reader via a button 362. The ADC reader reads the symbology via the light received at the window 360. In some embodiments, light such as laser light or light from light emitting diodes, may be emitted from the window 360 to illuminate the target.

The ADC user control includes a plurality of control buttons such as buttons 364 and 366. Control buttons include buttons for, among things, actuating the ADC device 190, canceling a read by the ADC device 190, and submitting data read by the ADC device 190. The button 364 may be a cancel button and the button 366 may be a submit button. The cancel button 364 may be used to stop the ADC reader 190 from reading a wireless device. The submit button 366 may be used to submit data read by the ADC reader 190 to the ADC subsystem 124. The ADC subsystem 124 may then transmit the data to the cargo management subsystem 108.

In the embodiment illustrated, the buttons 364 and 366 are disposed on a face 368. The ADC user control 128 includes a face 370 that is opposed to the face 368. The face 370 may include a “read button” (not shown). The read button may be used to actuate the ADC reader 190.

Typically the ADC user control 128 is in wireless communication with the computing device 340. Wireless communication allows the operator to use the ADC user control 128 even when the operator is not in the cabin 114. Wireless communication with the computing device 340 may be according to a protocol such as BLUETOOTH®.

In some embodiments, the ADC user control 128 may be embodied as a joystick. Movement of the joystick may provide commands to the ADC system 124. In some embodiments, the joystick may include one or more buttons for providing commands to the ADC subsystem 124.

In some embodiments, the ADC user control 128 may be embodied as a lever proximal to the lift assembly control levers 332.

In some embodiments, the ADC user control 128 may be embodied in a control assembly having one or more buttons for providing commands to the ADC subsystem 124.

In some embodiments, the ADC user control 128 may be embodied in a control assembly having a touch-sensitive interface such as a touch screen.

### Cargo Storage Facility

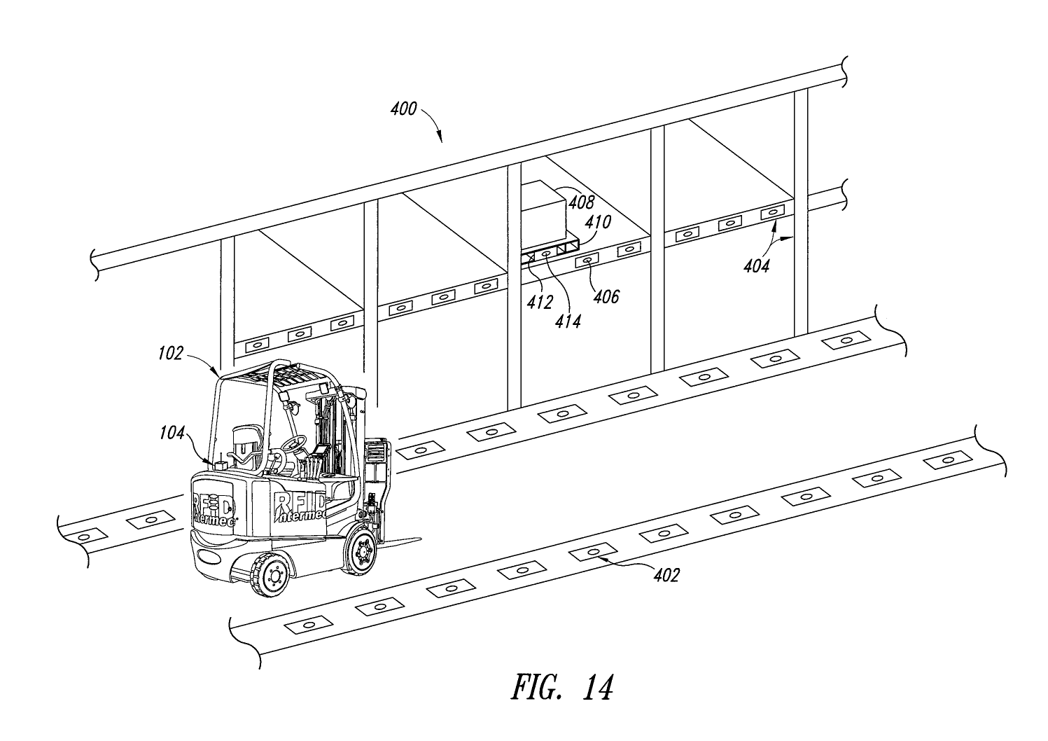

FIG. 14 shows an embodiment of the cargo transporter 102 and a portion of an exemplary cargo storage facility 400. The cargo transporter 102 is in wireless communication with the cargo management subsystem (see FIG. 1) via the wireless communication device 104 and network 106. The cargo management subsystem 108 includes components and/or logic that enables the cargo management subsystem 108 to track the cargo transporter 102 in the cargo storage facility 400.

The cargo storage facility 400 includes path indicators 402. The path indicators 402 may emit light to indicate the path that the cargo transporter 102 should follow. The path indicators 402 may be controlled by the cargo management subsystem 108 such that individual or multiple path indicators 402 are switched on to illuminate as the cargo transporter 102 approaches and then switched off after the cargo transporter 102 has gone past the previously switched-on path indicators 402. The path indicators 402 may be disposed on a surface such as a floor and/or other surfaces that are visible to the operator of the cargo transporter 102.

The cargo storage facility 400 includes shelving 404. The shelving 404 includes cargo location indicators 406. The cargo management subsystem 108 may individually control the cargo location indicators 406 such that the cargo management subsystem 108 may actuate a specific cargo location indicator 406. An individual cargo location indicator may be actuated so as to alert the operator of the cargo transporter 102 of the pickup location for cargo and/or the drop-off location for cargo.

Typically, cargo 408 is loaded on a pallet 410. The pallet 410 includes a pallet identifier subsystem 412. The pallet identifier subsystem 412 may be removably coupled to the pallet 410. The pallet identifier subsystem 412 may include an illumination device 414 and a wireless communication device such as an RFID device. The pallet identifier subsystem 412 may be powered via a battery and/or passively powered via electromagnetic waves.

The cargo management subsystem 108 may cause the illumination device 414 to illuminate upon command, thereby signaling the operator of the cargo transporter 102 as to which pallet to pick up.

In some embodiments, the cargo transporter 102 may interrogate the pallet identifier subsystem 412 via the ADC subsystem 124. The ADC subsystem 124 may alert the operator that the interrogated pallet is or is not a desired pallet. Similarly, if the interrogated pallet is the desired pallet, the illumination device may be actuated.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1.-9. (canceled)

10. A self-propelled cargo transportation device that lifts and moves cargo, the cargo transportation device comprising:
a propulsion system selectively operable to propel the self-propelled cargo transportation device;
a lift system physically coupled to the propulsion system for movement therewith, and selectively operable to raise and lower cargo moved thereby;
a load backrest physically coupled to at least a portion of the lift system;
an automatic data collection device physically coupled to the propulsion system for movement therewith, and configured to interrogate wireless communication devices attached to cargo at least when the cargo is at least proximate at least a portion of the lift system;
a display device physically coupled to the propulsion system for movement therewith, and operable provide information to an operator of the self-propelled cargo transportation device;
an image capture device physically coupled to the propulsion system for movement therewith, and operable to capture images; and
a computing device having at least one processor and at least one non-transitory processor-readable storage medium to store instructions executable by the at least one processor, the computing device physically coupled to the propulsion system for movement therewith and communicatively coupled to the automatic data collection device, the image capture device, and the display device, the computing device configured to control the image capture device at least in part in response to information received from the automatic data collection device.

11. The self-propelled cargo transportation device of claim 10 wherein the image capture device is positioned, oriented and controlled to record a condition of cargo when picked up by the cargo transportation device and a condition of the cargo when left by the cargo transportation device.

12. The self-propelled cargo transportation device of claim 10 wherein the computing device is configured to cause the image capture device to automatically capture an image based on at least one of a presence or an absence of a wireless communications device within a range of the automatic data collection device, a position of the self-propelled cargo transportation device or a position of a portion of the self-propelled cargo transport device with respect to another portion of the self-propelled cargo transportation device.

13. The self-propelled cargo transportation device of claim 12 wherein the wireless communication device is a radio frequency identification (RFID) transponder carried by the cargo and the automatic data collection device is an RFID interrogator.

14. The self-propelled cargo transportation device of claim 13 wherein the computing device causes the image capture device to capture an image when the RFID interrogator detects a new RFID transponder.

15. The self-propelled cargo transportation device of claim 13 wherein the image capture device automatically captures an image when the RFID interrogator loses communication with a previously detected RFID transponder.

16. The self-propelled cargo transportation device of claim 10, further comprising:
a steering wheel, wherein the display device is coupled to the steering wheel.

17. The self-propelled cargo transportation device of claim 10, further comprising:
a dashboard, wherein the display device is coupled to the dashboard.

18. The self-propelled cargo transportation device of claim 10, further comprising:
a cabin physically coupled to the propulsion system for movement therewith, the cabin having at least one post; and
a cable retainer coupled to the post of the cabin, the cable retainer configured to selectively retain at least one cable.

19. The self-propelled cargo transportation device of claim 18 wherein the cable retainer is magnetically coupled to the post.

20. The self-propelled cargo transportation device of claim 18 wherein the cable retainer includes at least one slot.

21. The self-propelled cargo transportation device of claim 18 wherein the cable retainer includes at least one notch defined by at least one of a cap or a base, and the cap is coupled to the base, and the base is coupled to the post.

22. The self-propelled cargo transportation device of claim 10 wherein the image capture device is wirelessly communicatively coupled with the computing device and configured to capture at least one of moving images or still images.

23. The self-propelled cargo transportation device of claim 10, further comprising:
a joystick communicatively coupled to control operation of the automated data collection device.

24. A self-propelled cargo transportation device that lifts and moves cargo, the cargo transportation device comprising:
a propulsion means for propelling the cargo transportation device;
a lift means for raising and lowering cargo, the lift means coupled to the propulsion means;
a cabin for an operator to operate propulsion and lift controls of the cargo transportation device;
a load backrest coupled to the lift means; an automatic data collection device configured to interrogate wireless communication devices, the automatic data collection device coupled to the load backrest;
a computing device having logic for controlling the automatic data collection device and logic for controlling the lift means and the propulsion means;
a display device in communication with the computing device and coupled to the cabin, the display device configured to provide the operator with information from the computing device;
an image capture device coupled to the load backrest and configured to automatically record the operation of the cargo transportation device; and
wherein the image capture device is in communication with the computing device and the computing device includes logic for actuating the image capture device.

25. The self-propelled cargo transportation device of claim 24, further comprising:
a means for steering the cargo transportation device, wherein the display device is coupled to the steering the means.

26. The self-propelled cargo transportation device of claim 24, further comprising:
a dashboard, wherein the display device is coupled to the dashboard.

27. The self-propelled cargo transportation device of claim 24, further comprising:
a cable retainer coupled to a post of the cabin, the cable retainer including means for receiving at least one cable.

28. The self-propelled cargo transportation device of claim 27 wherein the cable retainer is magnetically coupled to the post.

29. The self-propelled cargo transportation device of claim 27 wherein the cable retainer includes at least one slot.

30. The self-propelled cargo transportation device of claim 27 wherein the cable retainer includes at least one notch defined by at least one of a cap or a base, wherein the cap is coupled to the base, and the base is coupled to the post.

31. The self-propelled cargo transportation device of claim 24 wherein the image capture device is wirelessly connected with the computing device and configured to take video images and/or still images.

32. The self-propelled cargo transportation device of claim 31 wherein the logic causes the image capture device to automatically capture an image based on at least one of a presence or absence of a wireless communication device, a position of the self-propelled cargo transportation device and/or a position of a portion of the self-propelled cargo transport device with respect to another portion of the self-propelled cargo transportation device.

33. The self-propelled cargo transportation device of claim 32 wherein the wireless communication device is an RFID transponder.

34. The self-propelled cargo transportation device of claim 33 wherein the image capture device automatically captures an image when the automatic data collection device detects a new RFID transponder.

35. The self-propelled cargo transportation device of claim 33 wherein the image capture device automatically captures an image when the automatic data collection device is losing a communication with a previously detected RFID transponder.

36. The self-propelled cargo transportation device of claim 24 wherein the image capture device record a condition of the cargo picked up by the cargo transportation device and a condition of the cargo when left by the cargo transportation device.

37. The self-propelled cargo transportation device of claim 24 wherein the automated data collection device is operated by a joystick.
